(19) United States
(12) Patent Application Publication
(10) Pub. No.: US 2004/0098500 A1
(43) Pub. Date: May 20, 2004

(54) Flow control method for a virtual container trunk of metropolitan-area network transmission equipment

(76) Inventors: Mingwei Liu, Shenzhen (CN); Dawei Li, Shenzhen (CN)

Correspondence Address: HARNESS, DICKEY & PIERCE, P.L.C., P.O. BOX 828, BLOOMFIELD HILLS, MI, 48303, US

(21) Appl. No.: 10/702,376

(22) Filed: Nov. 5, 2003

(30) Foreign Application Priority Data
Nov. 8, 2002 (CN) 02148902.5

(51) Int. Cl. G06F 15/16

(52) U.S. Cl. 709/232

(57) ABSTRACT

The invention discloses a flow control method for VC-Trunks in metropolitan-area network equipment. The method at least includes following steps: Receiving-end transmission equipment determines whether there is a service data packet block in its VC-Trunk, if it is, a flow control packet with the VC-Trunk tag is sent out; The transmission equipment that has received the flow control packet pauses service data packets forwarding of the VC-Trunk according to the VC-Trunk tag in the flow control packet until the timing brought in by the flow control packet is ended and there is no other new flow control packet coming. The method can individually control data flow for each VC-Trunk, and comparing with the present technique the method solves problems that there is no flow control in SDH.

### CROSS-REFERENCE TO RELATED APPLICATIONS

This application claims the benefit of Chinese Patent Application No. 02148902.5 filed on Nov. 8, 2002. The disclosure of the above application is incorporated herein by reference.

### FIELD OF THE INVENTION

The invention relates to the data transmission field, specifically to a flow control method for a virtual container trunk (VC-Trunk) of metropolitan-area network transmission equipment based on Synchronous Digital Hierarchy (SDH).

### BACKGROUND OF THE INVENTION

In metropolitan-area network equipment based on SDH, IP data packet or ATM cell is mapped to SDH for transmission. When data are dropped from an optical fiber to a VC-Trunk, if the data dropping speed is faster than processing and forwarding speed of the equipment, the dropping data flow must be controlled.

When conventional SDH equipment transmits data to an optical fiber, the uplink bandwidth is definite; even there is some variant, the variance is within the range of rate adjustment recommended by G.707. Thus the receiving node on the transmission ring has enough processing capability for a VC-Trunk adding data; there is no flow control issue.

For metropolitan-area network equipment based on SDH, which loads service data, the data flow is changed constantly. Without flow control to a VC-Trunk, data loss will appear, data flow on the network is fluctuation, the network bandwidth cannot be efficiently used; also a VC-Trunk can occupy too much resource and affects other VC-Trunks normal service.

At present, the IEEE802.3x only provides flow control based on a physical port. There is no VC-Trunks flow control technique based on SDH.

### SUMMARY OF THE INVENTION

The objective of the invention is to provide a flow control method for VC-Trunks in the metropolitan-area network equipment. With this method data flow of every VC-Trunk is controlled individually.

A flow control method for VC-Trunks in metropolitan-area network transmission equipment comprises at least the following steps:

A) Receiving-end transmission equipment detects whether there is a service data packet block in its VC-Trunks, if it is, a flow control packet with the VC-Trunk tag is sent out;

B) The transmission equipment that has received the flow control packet pauses service data packets forwarding of the VC-Trunk according to the VC-Trunk tag in the flow control packet until the timing brought in by the flow control packet expires and there is no other new flow control packet comes.

Said Step (B) further comprises that initiating flow control timer at the transmission equipment that has received the flow control packet; detecting whether the flow control timing is ended; if it is not, then wait.

Said Step (A) further comprises that initiating control timer at the receiving-end transmission equipment and send said flow control packet in a timing manner until the service data packet block is disappeared.

It is better that said Step (A) also comprises that calculating individually number of received service data packets of every VC-Trunk at the receiving-end transmission equipment; detecting whether the number is excess the preset flow control threshold; if it is, send the flow control packet to the transmit-end transmission equipment.

It is better that Step (A) also comprises that detecting whether the FIFO buffer of a VC-Trunk at the receiving-end transmission equipment is overflow; if it is, send the flow control packet to the transmission equipment physical port of the receiving-end.

The flow control packet used in this invention is consisted of adding a VC-Trunk tag as a frame header to the 802.3x standard pause frame.

Said VC-Trunk tags correspond to VC-Trunks one by one, and the VC-Trunk tag length is determined by the number of VC-Trunks.

The invention applies adding a VC-Trunk tag as a header to the 802.3x standard pause frame to form a flow control packet that individually reflects a VC-Trunk block situation, so each VC-Trunk data flow can be individually controlled without any mutual affection among VC-Trunks. In the invention, the flow control packet can be sent by software or hardware, thus the implementation is flexible. Comparing with the conventional technique, the invention solves both problems: in the SDH system there is no flow control, and previously general flow control technique it is only based on the physical port.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of VC-Trunks flow control.

FIG. 2 is a service data packet format in a VC-Trunk.

FIG. 3 is a diagram of relationship between a physical port and VC-Trunks.

FIG. 4 is a processing flowchart of flow control for a VC-Trunk on the downlink of service data packets.

FIG. 5 is a flow control packet format.

FIG. 6 is flow direction diagram of service data packets inside the interface logic module on the uplink of service data packets.

FIG. 7 is a diagram for interface logic module sending flow control packet to a physical port.

FIG. 8 is a processing flowchart of a port during receiving a flow control packet.

### DETAILED DESCRIPTION OF THE PREFERRED EMBODIMENTS

The following description of the preferred embodiment(s) is merely exemplary in nature and is in no way intended to limit the invention, its application, or uses.

Usually, a same physical port comprises multiple VC-Trunks in metropolitan-area network transmission equipment. When making flow control for a VC-Trunk, it should be avoided to affect other VC-Trunks. This means that when a VC-Trunk has received flow control information, it should response in time and pause data transmitting without affecting the data stream that sends to other VC-Trunks. Therefore, the invention needs to solve issues including the identification of a VC-Trunk, transmitting and receiving of flow control information for a VC-Trunk, etc.

FIG. 1 shows a diagram of VC-Trunks flow control. On a SDH ring, there are four nodes and there is a VC-Trunk between two neighbor nodes. For example, between Node 2 and Node 3 there is a VC-Trunk. Suppose the service data packets are flowed from Node 2 to Node 3, and when there is an excess service data stream that Node 3 cannot forward; Node 3 will send a flow control signal to Node 2 and Node 2 will pause the service data sending.

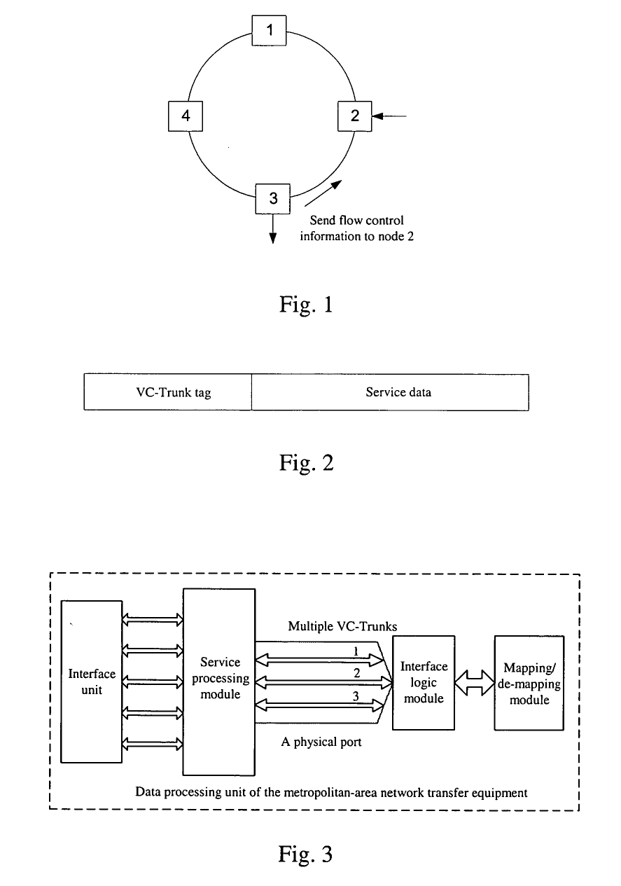

FIG. 2 shows a service data packet format in a VC-Trunk. In order to differentiate service data packets sent to different VC-Trunks, a VC-Trunk tag is added to the service data packet before the service data packet is mapped to the SDH channel. The length of the VC-Trunk tag depends on how many VC-Trunks the equipment supports. Each VC-Trunk tag corresponds to one VC-Trunk and a VC-Trunk tag value is uniquely set on the SDH ring.

FIG. 3 shows the relationship between a physical port and VC-Trunks in metropolitan-area network transmission equipment. A data processing unit in metropolitan-area network transmission equipment includes an interface unit, a service-processing module, interface logic module and a mapping/de-mapping module. The service-processing module is connected with the interface logic module through the physical port that includes several SDH VC-Trunks. On the uplink of service data packets, when a service data packet is mapped from a VC-Trunk to the SDH ring, it is located at different time slots according to the VC-Trunk tag of the service data packet. Since SDH is a time-division multiplexing system, data in a time slot can be sent to any node on the SDH ring; in this way a service data packet with a VC-Trunk tag can be transmitted to a designated node according to a configuration of network management center. On the downlink of service data packets, when data are mapped from the SDH ring to the VC-Trunk, the mapping/de-mapping module adds an appropriate VC-Trunk tag. After service data packets with different VC-Trunk tags enter the same physical port, the service-processing module forwards them according to the VC-Trunk tag and the virtual LAN identifier (VLAN ID) etc.

In the following, it is described that the receiving-end transmission equipment sends flow control information to the sending-end transmission equipment.

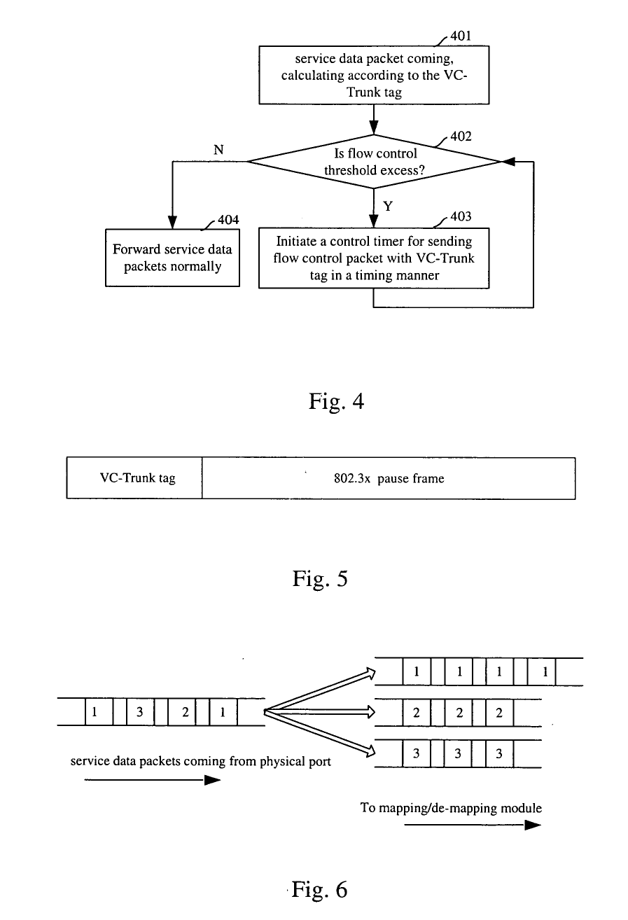

FIG. 4 is a processing flowchart of a flow control signal sent by the VC-Trunk of the transmission equipment at receiving-end.

Step 401. The receiving-end transmission equipment calculates respectively number of service data packets of every VC-Trunk in the shared packet memory according to the VC-Trunk tag of each service data packet and sets a threshold of service data packets number for flow control.

Step 402. Whether the number of service data packets is greater than the threshold is detected. If the number of service data packets is less than the threshold, then go to Step 404 to forward service data packets normally. If the service data packets number is greater than the threshold, then go to Step 403 and initiate a control timer in order to send a flow control packet with VC-Trunk tag to the sending-end transmission equipment in a timing manner. Structure of the flow control packet is shown in FIG. 5 and is consisted by adding a VC-Trunk tag in front of the IEEE802.3x pause frame to implement flow control for different VC-Trunks. Since each service data packet has its own VC-Trunk tag, a VC-Trunk can be differentiated from other VC-Trunks at the same physical port. For example, in FIG. 3 when the service-processing module has received service data packets mapped from SDH ring to VC-Trunks and the service data packets number of VC-Trunk 1 in the packet memory has been excess the threshold, the service-processing module sends a flow control packet with VC-Trunk tag value 1 to its physical port. The flow control packet is mapped from VC-Trunk 1 to the SDH ring by the mapping/de-mapping module, and then is transmitted to the physical port of sending-end transmission equipment. Service data packets with VC-Trunk tag value tag 2 and 3 are normally sent from the same physical port. In this way, a flow control based on VC-Trunk is implemented; there is no any mutual affection among the VC-Trunks.

The flow control manner mentioned above is implemented by software; threshold can be changed easily, so the flow control is flexible. When a service data packet is sent to a VC-Trunk, the trunk counter increases and when a service data packet is sent out from a VC-Trunk the trunk counter decreases; this will affect the forwarding efficiency in a certain degree.

Another flow control manner can be implemented by hardware; the interface logic module between the service-processing module and the mapping/de-mapping module in receiving-end transmission equipment will send the flow control packet with a VC-Trunk tag to the physical port according to the size of FIFO buffer of each VC-Trunk.

FIG. 6 shows on the uplink of service data packets the flow direction of service data packets inside the interface logic module of FIG. 3. The interface logic of the receiving-end transmission equipment allocates service data packets received from the physical port, to the FIFO buffer of different VC-Trunks according to the VC-Trunk tag of each service data packet; service data packets in the FIFO buffer of different VC-Trunks will be sent to the mapping/de-mapping module. Conversely, on the downlink of service data packets, VC-Trunk tag is added to service data packets according to which VC-Trunk the service data packet is coming from, and then sends to the service-processing module.

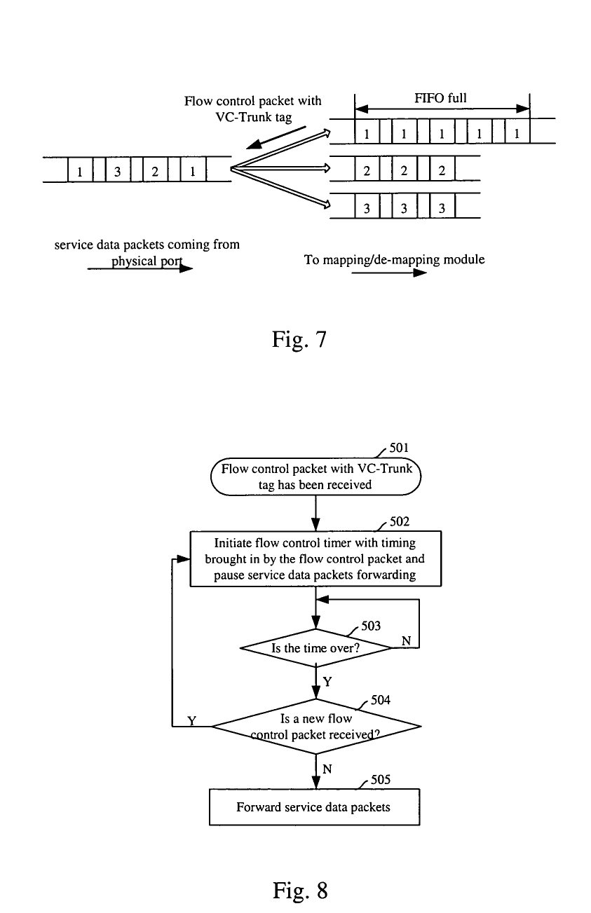

FIG. 7 shows sending of flow control packets of the interface logic module. When the FIFO buffer of a VC-Trunk is full, the interface logic module sends a flow control packet with the VC-Trunk tag to physical port of the service-processing module to simulate a flow control fame coming from the sending-end transmission equipment. Having received the flow control packet, the physical port pauses sending service data packets to the VC-Trunk; in this way, the flow of VC-Trunk is controlled.

When a flow control packet has been received, the processing procedure is as follow. After a flow control packet is received, the VC-Trunk tag of the flow control packet is analyzed to know that this flow control is for which VC-Trunk and the data flow for that VC-Trunk is paused. Consequently, the flow of VC-Trunk is controlled.

FIG. 8 shows a processing flowchart of flow control packet at the physical port of the receiving-end transmission equipment.

Step 501. The physical port receives a flow control packet with a VC-Trunk tag.

Step 502. The flow control timer is initiated with the timing brought in by the flow control packet, and the service data packets forwarding is paused.

Step 503. Whether the timing set at Step 502 is ended, if it is, execute Step 504, otherwise return to Step 503.

Step 504. Whether a new flow control packet has been received, if it is, return to Step 502, otherwise execute Step 505 for forwarding service data packets normally.

In Step 502, said pausing service data packets forwarding can be implemented by software or hardware. When implementing with hardware, a switching network chip that supports data flow dispatched and individually paused can be used. For example, the switching network chip within the nP3400 network processor, made by US AMCC Company, can separate a data flow into 16 sub-flows; each sub-flow corresponds to one VC-Trunk or one physical port and service data packets sent to a VC-Trunk or physical port can be paused individually. When implementing with software, one or multiple queues can be set for every VC-Trunk or physical port. When it is necessary to pause data sending from a VC-Trunk or physical port, dispatching the queue of the VC-Trunk or physical port is stopped and the queue is disconnected from the VC-Trunk or port, therefore no service data packet will be sent from the VC-Trunk or physical port.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A flow control method for VC-Trunks in metropolitan-area network equipment comprising the following steps:
A) determining whether a service data packet block existing at a VC-Trunk of a receiving-end transmission equipment, if so, sending out a flow control packet with a VC-Trunk tag;
B) according to the VC-Trunk tag in the flow control packet, pausing service data packets of the VC-Trunk forwarding at a transmission equipment that has received said flow control packet, until timing brought in by the flow control packet expires and no other new flow control packet is received.

2. The flow control method according to claim 1, wherein step (B) further comprising, initiating flow control timer at the transmission equipment that has received said flow control packet; determining whether said flow control timing is ended, if it is not, then waiting.

3. The flow control method according to claim 1, wherein step (A) further comprising, initiating control timer at the receiving-end transmission equipment and sending said flow control packet in a timing manner until said service data packet block is disappeared.

4. The flow control method according to claim 1, wherein step (A) comprising, on the downlink of the service data packets, calculating individually the number of the received service data packets of every VC-Trunk at receiving-end transmission equipment; determining whether said number is excess a preset flow control threshold, if it is, sending the flow control packet to sending-end transmission equipment.

5. The flow control method according to claim 1, wherein step (A) comprising, on the uplink of the service data packets, determining whether a FIFO buffer of a VC-Trunk at the receiving-end transmission equipment is overflow, if it is, sending said flow control packet to the receiving-end transmission equipment physical port.

6. The flow control method according to claim 1, wherein VC-Trunk tag as a frame header is added to 802.3x standard pause frame to consist the flow control packet.

7. The flow control method according to claim 1, wherein VC-Trunk tags correspond to VC-Trunks one by one, and the VC-Trunk tag length is determined by the number of VC-Trunks.
